(19) United States
(12) Patent Application Publication
(10) Pub. No.: US 2016/0349552 A1
(43) Pub. Date: Dec. 1, 2016

(54) DISPLAY PANEL, FABRICATING METHOD THEREOF AND DISPLAY DEVICE

(71) Applicant: BEO TECHNOLOGY GROUP CO., LTD., Beijing (CN)

(72) Inventors: Yue SHI, Beijing (CN); Xin GU, Beijing (CN); Jikai YAO, Beijing (CN); Guangkui QIN, Beijing (CN); Ming ZHU, Beijing (CN); Miki KASHIMA, Beijing (CN); Yafeng YANG, Beijing (CN)

(73) Assignee: BEO TECHNOLOGY GROUP CO., LTD., Beijing (CN)

(21) Appl. No.: 14/907,435

(22) PCT Filed: Jul. 21, 2015
(86) PCT No.: PCT/CN2015/084552

§ 371 Date: Jan. 25, 2016

(30) Foreign Application Priority Data
Dec. 3, 2014 (CN) 201410725287.4

(51) Int. Cl. G02F 1/1339; G02F 1/1337

(52) U.S. Cl. CPC G02F 1/1339; G02F 1/1337

(57) ABSTRACT

A display panel, a fabricating method thereof and a display device are provided. The display panel comprises: a first substrate (1); a second substrate (2), opposed to the first substrate (1); a sealant (3), disposed between the first substrate (1) and the second substrate (2) to seal the first substrate (1) and the second substrate (2), and the sealant (3) between adjacent display regions (10,11) between the first substrate (1) and the second substrate (2) including a pre-cutting position (a-a′); and a curing barrier layer (5), disposed at a position corresponding to the pre-cutting position on a surface facing the second substrate (2) of the first substrate (1) and/or on a surface facing the first substrate (1) of the second substrate (2). The sealant (3) covers the curing barrier layer (5). According to the display panel and the fabricating method thereof, the success rate of the sealant (3) break can be increased, and the design of the narrow bezel can be achieved.

### FIELD

The present disclosure relates to a display panel, a fabricating method thereof, and a display device.

### BACKGROUND

With the development of the science technology and the society, an ultra-thin, narrow bezel, high quality LCD display panel increasingly gain the favor of the people, thus many display enterprises have invested enormous human and material resources in these directions for research and development. Conventionally, in order to achieve the narrow bezel of the LCD display panel, the adjacent display screens located on the same display panel share the same sealant, then the shared sealant is cut in the display screen cutting process.

However, a hardness of the cured sealant is relative high. It may happen that a central region of the shared sealant cannot completely break upon being cut. As such, the design of the ultra narrow bezel display panel cannot be achieved by the method of sharing the sealant, and in severe cases, it may even damage the display panel, affect the performance of the display panel, and make the finally formed display panels unavailable.

### SUMMARY

The embodiments of present disclosure provide a display panel, a fabricating method thereof, and a display device, which increase the success rate of the sealant break in the display screen cutting process, to achieve the design of the narrow bezel; furthermore, which also reduce the production cost and improve the performance of the display device. According to one aspect of the present disclosure, a display panel is provided, which comprises: a first substrate; a second substrate, opposed to the first substrate; a sealant, disposed between the first substrate and the second substrate to seal the first substrate and the second substrate, and the sealant between adjacent display regions between the first substrate and the second substrate including a pre-cutting position; and a curing barrier layer, disposed at a position corresponding to the pre-cutting position on a surface facing the second substrate of the first substrate and/or on a surface facing the first substrate of the second substrate, wherein the sealant covers the curing barrier layer.

Optionally, a size of a region in which the curing barrier layer is located on the surface of the first substrate or the second substrate is equal to a size of a region corresponding to the pre-cutting position on the surface of the first substrate or the second substrate.

Optionally, the pre-cutting position is a position corresponding to a central axis of the sealant shared by the adjacent display regions, and a direction of the central axis is a direction perpendicular to a direction of a line width of the sealant between the adjacent display regions.

Optionally, the display panel further comprises a first alignment layer disposed on the surface facing the second substrate of the first substrate, wherein, the curing barrier layer is disposed in a same layer as the first alignment layer.

Optionally, a material of the curing barrier layer is a same as that of the first alignment layer.

Optionally, the display panel further comprises a second alignment layer disposed on the surface facing the first substrate of the second substrate, wherein, the curing barrier layer is disposed in a same layer as the second alignment layer. Optionally, a material of the curing barrier layer is a same as that of the second alignment layer.

Optionally, a thickness of the curing barrier layer is about 800 A -1300 A.

According to another aspect of present disclosure, a method for fabricating a display panel is provided, which comprises: providing a first substrate; providing a second substrate opposed to the first substrate; disposing a sealant between the first substrate and the second substrate to seal the first substrate and the second substrate, the sealant between adjacent display regions between the first substrate and the second substrate comprising a pre-cutting position; forming a curing barrier layer on a surface facing the second substrate of the first substrate and at a position corresponding to the pre-cutting position, and/or, forming a curing barrier layer on a surface facing the first substrate of the second substrate and at a position corresponding to the pre-cutting position, wherein the sealant covers the curing barrier layer.

Optionally, the method further comprises: forming a first alignment layer on the surface facing the second substrate of the first substrate; forming a curing barrier layer on a surface facing the second substrate of the first substrate and at a position corresponding to the pre-cutting position comprises: forming the curing barrier layer in a same layer as the first alignment layer and at the position corresponding to the pre-cutting position.

Optionally, the method further comprises: forming a second alignment layer on the surface facing the first substrate of the second substrate; forming a curing barrier layer on a surface facing the first substrate of the second substrate and at a position corresponding to the pre-cutting position comprising forming the curing barrier layer in a same layer of the second alignment layer and at a position corresponding to the pre-cutting position.

Optionally, forming the curing barrier layer in a same layer of the second alignment layer and at a position corresponding to the pre-cutting position comprising: forming the curing barrier layer with a same material as the second alignment layer in a same layer of the second alignment layer and at the position corresponding to the pre-cutting position by using a same process of forming the second alignment layer.

According to still another aspect of present disclosure, a display device is provided, which comprises any one of the display panels as described above.

According to the display panel, the fabricating method thereof, and the display device provided in the embodiments of present disclosure, a curing barrier layer is disposed at the pre-cutting position of the sealant between the adjacent display regions, therefore, the sealant between the adjacent display regions at the pre-cutting position will not be cured during the UV irradiation curing, so that the sealant at this position will be easy to break. Then it can be ensured that the sealant will break at the pre-cutting position during the cutting process, to achieve the narrow bezel design of the display panel. According to present disclosure, the display screens will be available rather than defective due to the accurate break position, which in turn reduces the production cost and improves the performance of the display screen.

### BRIEF DESCRIPTION OF THE DRAWINGS

In order to describe the technical solutions in the embodiments of the present disclosure more clearly, accompanying drawings used in the description will be described briefly. It is apparent that the drawings mentioned in the following description are only some embodiments of the present disclosure, and various other drawings can be obtained by those of ordinary skilled in the art without creative labor based on these drawings mention above.

FIG. 1 is a structure schematic view of a display panel before a cutting process according to an embodiment of present disclosure;

FIG. 2 is a structure schematic view of another display panel before a cutting process according to an embodiment of present disclosure;

FIG. 3 is a structure schematic view of still another display panel before a cutting process according to an embodiment of present disclosure;

FIG. 4 is a structure schematic view of still another display panel before a cutting process according to an embodiment of present disclosure;

FIG. 5 is a structure schematic view of still another display panel before a cutting process according to an embodiment of present disclosure;

FIG. 6 is a structure schematic view of still another display panel before a cutting process according to an embodiment of present disclosure;

FIG. 7 is a flow chart of a method for fabricating a display panel according to an embodiment of present disclosure;

FIG. 8 is a flow chart of another method for fabricating a display panel according to an embodiment of present disclosure;

FIG. 9 is a flow chart of still another method for fabricating a display panel according to an embodiment of present disclosure; and

FIG. 10 is a flow chart of still another method for fabricating a display panel according to an embodiment of present disclosure.

Reference: 1-first substrate; 2-second substrate; 3-sealant; 4-liquid crystal; 5-curing barrier layer; 6-first alignment layer; 7-second alignment layer.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Unless otherwise defined, technical terms or scientific terms used herein shall have a common meaning known by those skilled in the art of the present disclosure. Words and expressions such as “first”, “second” and the like used in the description and claims of the patent application of the present disclosure do not denote any sequence, quantity or significance, but distinguish different components. Likewise, words such as “a”, “an” and the like do not denote quantitative restrictions, but denote the presence of at least one. Words such as “connected”, “connecting” and the like are not restricted to physical or mechanical connections, but may include electrical connections, regardless of direct or indirect connections. Words such as “up”, “below”, “left”, “right”, etc., are only used to denote the relative positional relationship. In a case where the absolute position of the described object changes, the relative positional relationship change correspondingly.

An embodiment of present disclosure provides a display panel. As illustrated in FIGS. 1-3, the display panel includes a first substrate 1, a second substrate 2 opposed to the first substrate 1, and a sealant 3 and liquid crystal 4 disposed between the first substrate 1 and the second substrate 2. The display panel includes adjacent display regions 10 and 11. The sealant 3 is disposed in a peripheral region of the first substrate 1 and the second substrate 2 and between the adjacent display regions 10 and 11, to seal the display regions 10 and 11 between the first substrate 1 and the second substrate 2. The liquid crystal 4 is dropped in the display regions 10 and 11 between the first substrate 1 and the second substrate 2. The sealant 3 between the adjacent display regions 10 and 11 includes a pre-cutting position a-a′. The pre-cutting position a-a′ is located at a central axis of the sealant 3 between the adjacent display regions 10 and 11, a direction of the central axis is a direction perpendicular to a direction of a line width of the sealant 3 between the adjacent display regions 10 and 11. The display panel also includes a curing barrier layer 5 disposed at a position corresponding to the pre-cutting position a-a′.

In one example, as illustrated in FIG. 1, the curing barrier layer 5 may be disposed at a position corresponding to the pre-cutting position a-a′ on an upper surface of the first substrate 1. The sealant 3 between the adjacent display regions 10 and 11 covers the curing barrier layer 5. Herein, in a case that the sealant 3 between the adjacent display regions 10 and 11 covers the curing barrier layer 5 refers to that the sealant 3 between the adjacent display regions 10 and 11 may be at least formed on an upper surface of the curing barrier layer 5 away from the first substrate 1 and two opposed side surfaces of the curing barrier layer 5 parallel to the central axis of the sealant 3.

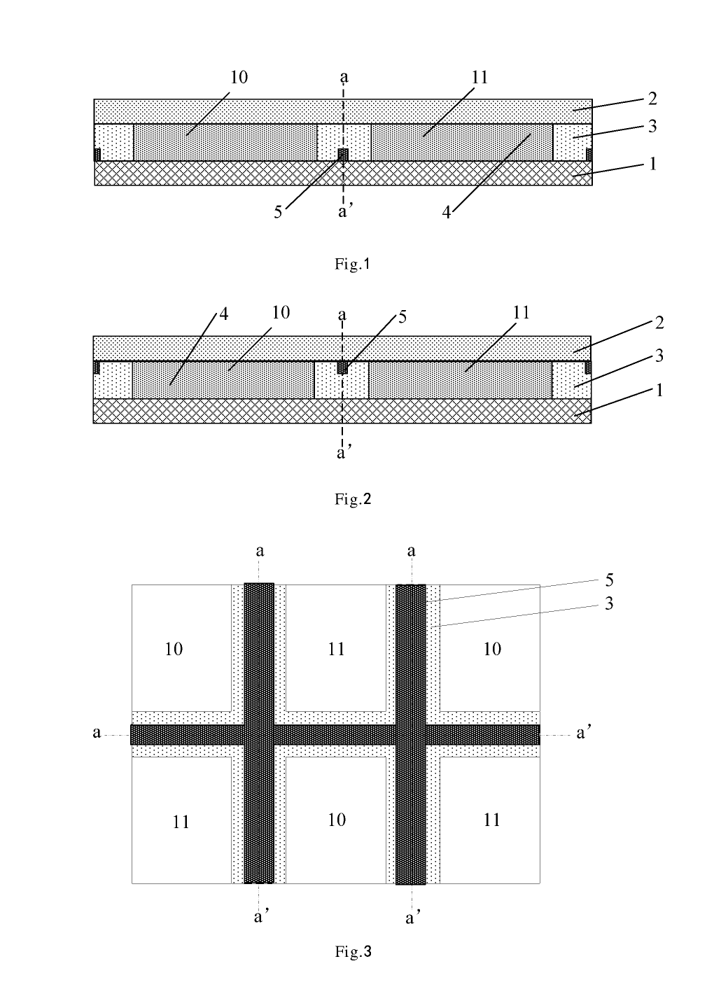

In another example, as illustrated in FIGS. 2 and 3, the curing barrier layer 5 may further be disposed at a position corresponding to the pre-cutting position a-a′ on a lower surface of the second substrate 2. The sealant 3 between the adjacent display regions 10 and 11 covers the curing barrier layer 5. The curing barrier layer 5 blocks light for curing the sealant 3, such as ultraviolet (UV) light, so that the sealant 3 located at the pre-cutting position a-a′ corresponding to the curing barrier layer 5 will not be cured during the curing process for the sealant 3.

n a case where the UV light irradiates the first substrate 1 side to cure the sealant 3, the curing barrier layer 5 is disposed on the upper surface of the first substrate 1, as illustrated in FIG. 1. In a case where the UV light irradiates the second substrate 2 side to cure the sealant 3, the curing barrier layer 5 is disposed on the lower surface of the second substrate 2, as illustrated in FIG. 2. The present disclosure is not limited thereto. In actual design, the curing barrier layer 5 may be disposed at any position, as long as the curing barrier layer 5 can block the light toward the sealant at the pre-cutting position during the curing process for the sealant.

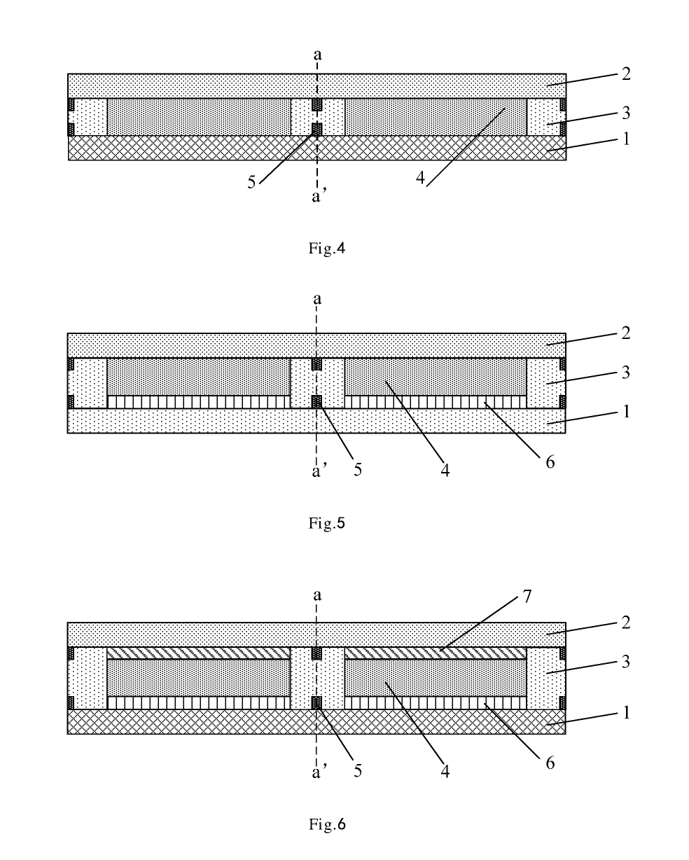

In another example, as illustrated in FIG. 4, the curing barrier layer 5 may be disposed both on the upper surface of the first substrate 1 and on the lower surface of the second substrate 2 at a position corresponding to the pre-cutting position a-a′.

It should be noted that, the pre-cutting position a-a′ is a cutting position disposed in the sealant to achieve the narrow bezel during the actual fabricating process of the display panel. For example, the pre-cutting position in the present embodiment is located at the central axis of the sealant between the adjacent display regions, and the central axis is parallel to a cutting direction of the display panel. In actual design, a periphery of the effective display region of the display panel is designed with an alignment mark (not illustrated). The pre-cutting position a-a′ may be disposed according to the alignment mark. The curing barrier layer 5 in present disclosure is disposed at a position corresponding to the pre-cutting position a-a′. The sealant at such position will not be irradiated by the UV light, and will not be cured, and will be easy to break upon being cut.

For example, the first substrate 1 may be an array substrate, and the second substrate 2 may be a color filter substrate; or, the first substrate 1 may be a color filter substrate, and the second substrate 2 may be an array substrate. The curing barrier layer may be an UV barrier layer which blocks the UV light.

The display panel according to the embodiments of present disclosure includes: a first substrate, a second substrate opposed to the first substrate, a sealant disposed between the first substrate and the second substrate to seal the first substrate and the second substrate. The sealant is disposed between the first substrate and the second substrate, comprising a peripheral region and a region between the adjacent display regions. The sealant between the adjacent display regions also includes a pre-cutting position. Furthermore, the display panel also includes a curing barrier layer at a position corresponding to the pre-cutting position, and the curing barrier layer is disposed on the first substrate, or on the second substrate, and is covered by the sealant. Since the sealant needs UV curing, and the hardness of the cured sealant is relative high, the cured sealant is not easy to break during the cutting process for the display panel, and it may happen that a fracture surface is not located at the cutting position of the sealant between the adjacent display regions. In the present disclosure, a curing barrier layer is disposed at a position corresponding to the pre-cutting position of the sealant between the adjacent display regions. As such, it can be ensured that the sealant at the pre-cutting position between the adjacent display regions will not be cured during UV irradiation curing, so that the sealant at such position will be easy to break. Then it can be ensured that the sealant will break at the pre-cutting position during cutting process, to achieve the narrow bezel design of the display panel. With the display panel according to the present disclosure, the display screen will be available rather than defective due to the accurate break position, which in turn reduces the production cost and improves the performance of the display screen.

Furthermore, for example, as illustrated in FIG. 5, the curing barrier layer 5 is disposed both on the upper surface of the first substrate and the lower surface of the second substrate, and the curing barrier layer 5 is covered by the sealant 3. The display panel further includes a first alignment layer 6 disposed on the upper surface of the first substrate 1. The curing barrier layer 5 is disposed in the same layer of the first alignment layer 6 at a position corresponding to the pre-cutting position a-a′.

The material of the curing barrier layer 5 is the same as that of the first alignment layer 6.

Exemplarily, the curing barrier layer 5 in the same layer of the first alignment layer 6 may be formed simultaneously with the first alignment layer 6, i.e., the first alignment layer 6 and the curing barrier layer 5 may be formed in one process. For example, a novel relief printing plate, APR plate, which may include a protrusion at a position corresponding to the pre-cutting position, may be used. The same material of the first alignment layer may be disposed at the protrusion position, so that the first alignment layer and the curing barrier layer made of the same material and formed in the same layer may be formed in one process. The present embodiment is only one example of how the first alignment layer and the curing barrier layer are formed in one process, the present disclosure is not limited thereto. Any method for forming the first alignment layer and the curing barrier layer in one process may be used.

Furthermore, as illustrated in FIG. 6, the display panel further includes a second alignment layer 7 disposed on the lower surface of the second substrate 2. The curing barrier layer 5 is disposed in the same layer of the second alignment layer 7 at a position corresponding to the pre-cutting position a-a′.

The material of the curing barrier layer 5 is the same as that of the second alignment layer 7.

Specially, the curing barrier layer in the same layer of the second alignment layer may be formed together with the second alignment layer, i.e., the second alignment layer and the curing barrier layer may be formed in one process. For example, a novel relief printing plate, APR plate, which may include a protrusion at a position corresponding to the pre-cutting position, may be used. The same material of the second alignment layer may be disposed at the protrusion position, so that the second alignment layer and the curing barrier layer made of the same material and formed in the same layer may be formed in one process. The present embodiment is only one example of how the second alignment layer and the curing barrier layer are formed in one process, the present disclosure is not limited thereto. Any method for forming the second alignment layer and the curing barrier layer in one process may be used. A thickness of the curing barrier layer is for example about 800-1300 Å.

The curing barrier layer provided in present disclosure may be disposed only in the same layer of the first alignment layer at a position corresponding to the pre-cutting position. In this case, the material of the curing barrier layer may be the same as that of the first alignment layer. Or, the curing barrier layer may be disposed only in the same layer of the second alignment layer at a position corresponding to the pre-cutting position, and the material of the curing barrier layer may be the same as that of the second alignment layer.

It should be noted that, a width of the curing barrier layer may be as small as possible under the premise that it can cover the pre-cutting position. For example, a size of a region where the curing barrier layer is located on a surface of the first substrate or the second substrate is equal to a size of a region corresponding to the pre-cutting position on the surface of the first substrate or the second substrate. It may also be understood that a width of the curing barrier layer is the same as that of the pre-cutting position. Thus, a case that the sealant at the pre-cutting position is not cured and the sealant in other positions may be all cured, can be obtained. If the width of the curing barrier layer is too large, an area of the uncured sealant in a finally formed display device will be too large, which will result in the deformation of liquid crystal molecules around the sealant because they can not be stably fixed at an origin position, and will affect the display performance of the finally formed display device. The material of the curing barrier layer is not limited thereto herein, and all of the materials which can block the UV light without affecting the display performance of the display device may be used as the material of the curing barrier layer.

The display panel according to the embodiments of present disclosure includes: a first substrate, a second substrate opposed to the first substrate, a sealant disposed in a peripheral region between the first substrate and the second substrate to seal the first substrate and the second substrate, and the sealant between the adjacent display regions between the first substrate and the second substrate includes a pre-cutting position. Furthermore, a curing barrier layer is disposed at a position corresponding to the pre-cutting position on the first substrate, and/or at a position corresponding to the pre-cutting position on the second substrate. Since the sealant needs UV curing, and the hardness of the cured sealant is relative high, the cured sealant is not easy to break during the cutting process for the display panel, and a fracture surface may be not located at the cutting position of the sealant between the adjacent display regions. In the present disclosure, a curing barrier layer is disposed at the pre-cutting position of the sealant between the adjacent display regions. As such, it can be ensured that the sealant at the pre-cutting position between the adjacent display regions will not be cured during UV irradiation curing, so that the sealant at such position will be easy to break. Then it can be ensured that the sealant will break at the pre-cutting position during cutting process, to achieve the narrow bezel design of the display panel. According to the display panel in the present embodiment, the display screen will be available rather than defective due to the accurate break position, which in turn reduces the production cost and improves the performance of the display screen.

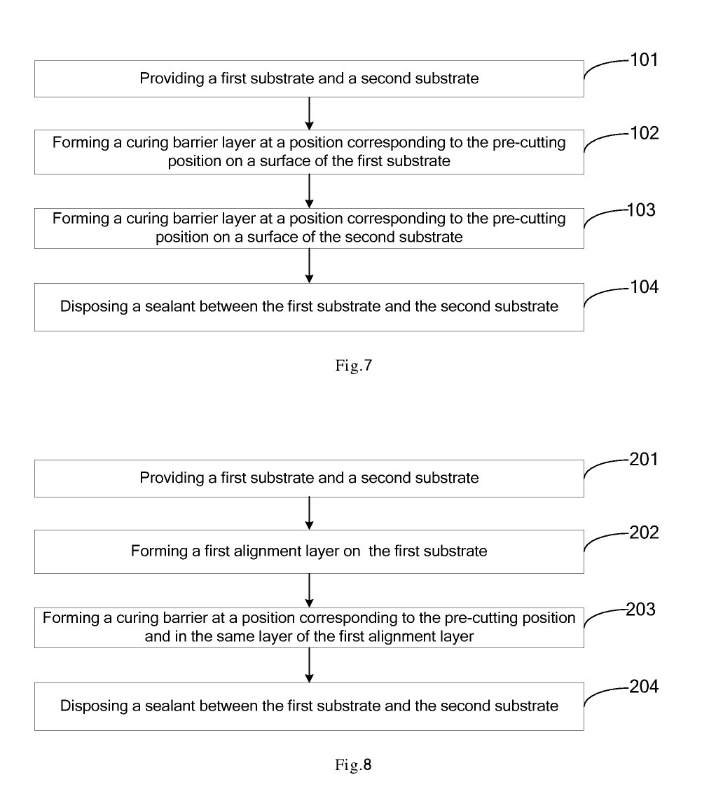

An embodiment of present disclosure provides a method for fabricating a display panel, as illustrated in FIG. 7, which includes the following steps:

101. Providing a first substrate and a second substrate opposed to the first substrate.

102. Forming a curing barrier layer at a position corresponding to the pre-cutting position on a surface facing the second substrate of the first substrate.

Herein, a sealant covers the curing barrier layer.

103. Forming a curing barrier layer at a position corresponding to the pre-cutting position on a surface facing the first substrate of the second substrate.

Herein, a sealant covers the curing barrier layer.

It should be noted that, there is no execution order between the step 102 of forming the curing barrier on the first substrate and the step 103 of forming the curing barrier on the second substrate, and in actual implementation, the execution order may be determined according to the layer structure of the display device specially designed.

104. Disposing a sealant between the first substrate and the second substrate, for example, in a peripheral region to seal the substrate and the second substrate.

The sealant between the adjacent display regions between the first substrate and the second substrate includes a pre-cutting position.

A thickness of the curing barrier layer may be for example about 800˜1300 Å.

In the above described method, after the step 101, only the steps 102 and 104 may be executed; or only the step 103 and 104 may be executed; or the steps 102-104 may be executed, the execution step may be chosen according to the layer structure of the display device actually designed.

It should be noted that, the pre-cutting position is a cutting position disposed in the sealant to achieve the narrow bezel during the implementing of the actual fabricating process for the display panel. For example, the pre-cutting position in an embodiment is located at a central axis of the sealant between the adjacent display regions, and the central axis is parallel to a cutting direction of the display panel. In actual design, a periphery of an effective display region of the display panel is designed with alignment marks. The pre-cutting position a-a′ may be disposed according to the alignment marks. The curing barrier layer in the present disclosure is disposed at a position corresponding to the pre-cutting position, so the sealant in such position will not be irradiated by the UV light, and will not be cured, and will be easy to break upon being cut.

It should be noted that, a width of the curing barrier layer may be as small as possible under the premise that it can cover the pre-cutting position. For example, a size of a region where the curing barrier layer is located on a surface of the first substrate or the second substrate is equal to a size of a region corresponding to the pre-cutting position on the surface of the first substrate or the second substrate. It may also be understood that the width of the curing barrier layer is the same as that of the pre-cutting position. Thus, a case that the sealant at the pre-cutting position is not cured and the sealant in other positions may be all cured, can be obtained. the yield of the product can be guaranteed.

The method for fabricating a display panel according to the embodiments of present disclosure includes: providing a first substrate, and a second substrate opposed to the first substrate, and disposing a sealant between the first substrate and the second substrate , for example, in a peripheral region to seal the first substrate and the second substrate, wherein the sealant between the adjacent display regions between the first substrate and the second substrate includes a pre-cutting position. Furthermore, a curing barrier layer is disposed at a position corresponding to the pre-cutting position on the first substrate, and/or at a position corresponding to the pre-cutting position on the second substrate. Since the sealant needs UV curing, and the hardness of the cured sealant is relative high, the cured sealant is not easy to break during the cutting process for the display panel, and a fracture surface may be not located at the cutting position of the sealant between the adjacent display regions. In the present disclosure, a curing barrier layer is disposed at the pre-cutting position of the sealant between the adjacent display regions. As such, it can be ensured that the sealant at the pre-cutting position between the adjacent display regions will not be cured during UV irradiation curing, so that the sealant at such position will be easy to break. Then it can be ensured that the sealant will break at the pre-cutting position during cutting process, to achieve the narrow bezel design of the display panel. According to the fabricating method of the display panel in the present embodiment, the display screen will be available rather than defective due to the accurate break position, which in turn reduces the production cost and improves the performance of the display screen.

An embodiments of present disclosure provides another method for fabricating a display panel, as illustrated in FIG. 8, which includes the following steps:

201. Providing a first substrate and a second substrate opposed to the first substrate.

202. Forming a first alignment layer on a surface facing the second substrate of the first substrate.

203. Forming a curing barrier at a position corresponding to the pre-cutting position, and the curing barrier being in the same layer of the first alignment layer.

Exemplarily, the step 203 may be achieved as following.

Forming the curing barrier layer with the same material as that of the first alignment layer in the same layer of the first alignment layer at a position corresponding to the pre-cutting position by using same process for forming the first alignment layer.

It should be noted that, the step 202 of forming the first alignment layer may be performed simultaneously with the step 203 of forming the curing barrier layer. Exemplarily, a novel relief printing plate, APR plate, which may include a protrusion at a position corresponding to the pre-cutting position, may be used. The material for forming the curing barrier layer may be disposed at the protrusion position, so that the first alignment layer and the curing barrier layer made of the same material and formed in the same layer may be formed in one process. The present embodiment is only one example that the first alignment layer and the curing barrier layer are formed in one process using the novel APR plate, the present disclosure is not limited thereto. Any method for forming the first alignment layer and the curing barrier layer in one process may be used.

The material of the curing barrier layer is not limited thereto herein, and any material which can block the UV light without affecting the display performance of the display device may be used as the material of the curing barrier layer.

204. Disposing a sealant between the first substrate and the second substrate, for example, in a peripheral region to seal the first substrate and the second substrate.

The sealant between the adjacent display regions between the first substrate and the second substrate includes a pre-cutting position.

In the present embodiment, a curing barrier layer is formed at a position corresponding to the pre-cutting position in the same layer of the first alignment layer on the first substrate. In a case that the UV light irradiates the first substrate side to cure the sealant, it can be effectively ensured that the sealant at the cutting position of the sealant will not be cured due to the presence of the curing barrier layer, and it can be ensured that the sealant will break at the cutting position during cutting process, which achieves the narrow bezel.

The method for fabricating a display panel according to the embodiments of present disclosure includes: providing a first substrate, and a second substrate opposed to the first substrate, and disposing a sealant between the first substrate and the second substrate , for example, in a peripheral region to seal the first substrate and the second substrate, wherein the sealant between the adjacent display regions between the first substrate and the second substrate includes a pre-cutting position. Furthermore, a curing barrier layer is disposed at a position corresponding to the pre-cutting position on the first substrate, and/or at a position corresponding to the pre-cutting position on the second substrate. Since the sealant needs UV curing, and the hardness of the cured sealant is relative high, the cured sealant is not easy to break during the cutting process for the display panel, and a fracture surface may be not located at the cutting position of the sealant between the adjacent display regions. In the present disclosure, a curing barrier layer is disposed at the pre-cutting position of the sealant between the adjacent display regions. As such, it can be ensured that the sealant at the pre-cutting position between the adjacent display regions will not be cured during UV irradiation curing, so that the sealant at such position will be easy to break. Then it can be ensured that the sealant will break at the pre-cutting position during cutting process, to achieve the narrow bezel design of the display panel. According to the fabricating method of the display panel in the present embodiment, the display screen will be available rather than defective due to the accurate break position, which in turn reduces the production cost and improves the performance of the display screen.

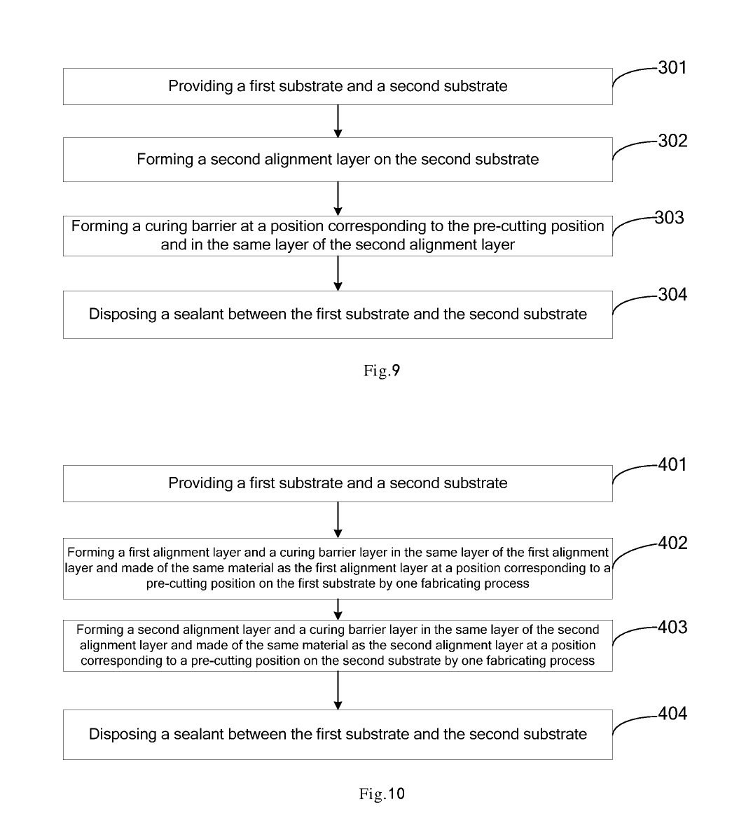

An embodiment of present disclosure provides another method for fabricating a display panel, as illustrated in FIG. 9, which includes the following steps:

301. Forming a first substrate and a second substrate opposed to the first substrate.

302. Forming a second alignment layer on a surface facing the first substrate of the second substrate.

303. Forming a curing barrier layer in the same layer of the second alignment layer at a position corresponding to a pre-cutting position.

Exemplarily, the step 303 may be achieved as following:

Forming the curing barrier layer with the same material as that of the second alignment layer in the same layer of the second alignment layer at a position corresponding to the pre-cutting position by using same process for forming the second alignment layer.

It should be noted that, the step 302 of forming the second alignment layer may be performed simultaneously with the step 303 of forming the curing barrier layer. Exemplarily, a novel APR plate, which may include a protrusion at a position corresponding to the pre-cutting position, may be used. The material for forming the curing barrier layer may be disposed at the protrusion position, so that the second alignment layer and the curing barrier layer made of the same material and formed in the same layer may be formed in one process. The present embodiment is only one example that the second alignment layer and the curing barrier layer are formed by one process using the novel APR plate, the present disclosure is not limited thereto. Any method for forming the second alignment layer and the curing barrier layer by one process may be used.

The material of the curing barrier layer is not limited thereto herein, and any material which can block the UV light without affecting the display performance of the display device may be used as the material of the curing barrier layer.

304. Disposing a sealant in a peripheral region between the first substrate and the second substrate to seal the first substrate and the second substrate.

Herein, the adjacent display regions on the first substrate and the second substrate share the same sealant, and the sealant shared by the adjacent display regions includes the pre-cutting position.

In the present embodiment, the curing barrier layer is formed at a position corresponding to the pre-cutting position in the same layer of the second alignment layer on the second substrate. In a case that the UV light irradiates the second substrate side to cure the sealant, it can be effectively ensured that the sealant at the cutting position of the sealant will not be cured due to the presence of the curing barrier layer, and it can be ensured that the sealant will break at the cutting position during cutting process, which achieves the narrow bezel.

The method for fabricating a display panel according to the embodiments of present disclosure includes: providing a first substrate, and a second substrate opposed to the first substrate, and disposing a sealant between the first substrate and the second substrate , for example, in a peripheral region to seal the first substrate and the second substrate, wherein the sealant between the adjacent display regions between the first substrate and the second substrate includes a pre-cutting position. Furthermore, a curing barrier layer is disposed at a position corresponding to the pre-cutting position on the first substrate, and/or at a position corresponding to the pre-cutting position on the second substrate. Since the sealant needs UV curing, and the hardness of the cured sealant is relative high, the cured sealant is not easy to break during the cutting process for the display panel, and a fracture surface may be not located at the cutting position of the shared sealant. In the present disclosure, a curing barrier layer is disposed at the pre-cutting position of the sealant between the adjacent display regions. As such, it can be ensured that the sealant at the pre-cutting position between the adjacent display regions will not be cured during UV irradiation curing, so that the sealant at such position will be easy to break. Then it can be ensured that the sealant will break at the pre-cutting position during cutting process, to achieve the narrow bezel design of the display panel. According to the method for fabricating the display panel in the present embodiment, the display screen will be available rather than defective due to the accurate break position, which in turn reduces the production cost and improves the performance of the display screen.

An embodiment of the present disclosure provides another method for fabricating a display panel, as illustrated in FIG. 10, which includes the following steps:

401. Providing a first substrate and a second substrate opposed to a first substrate.

402. Forming a first alignment layer and a curing barrier layer in the same layer of the first alignment layer and made of the same material as the first alignment layer at a position corresponding to a pre-cutting position on a surface facing the second substrate of the first substrate by one fabricating process.

403. Forming a second alignment layer and a curing barrier layer in the same layer of the second alignment layer and made of the same material as the second alignment layer at a position corresponding to a pre-cutting position on a surface facing the first substrate of the second substrate by one fabricating process.

It should be noted that, there is no execution order between the step 402 and the step 403, the step 402 and the step 403 may be performed simultaneously. The execution order may be determined according to the actual design.

404. Disposing a sealant between the first substrate and the second substrate, for example, in a peripheral region to seal the first substrate and the second substrate. Herein, the sealant between the adjacent display regions between the first substrate and the second substrate includes the pre-cutting position.

In the present embodiment, the curing barrier layer is formed both at a position corresponding to the pre-cutting position in the same layer of the second alignment layer on the second substrate and at a position corresponding to the pre-cutting position in the same layer of the first alignment layer on the first substrate. Thus, In a case that the UV light irradiates the second substrate side to cure the sealant and in a case that the UV light irradiates the first substrate side to cure the sealant, it can be effectively ensured that the sealant at the cutting position of the sealant will not be cured due to the presence of the curing barrier layer, and it can be ensured that the sealant will break at the cutting position during cutting process, which achieves the narrow bezel.

The method for fabricating a display panel according to the embodiments of present disclosure includes: providing a first substrate, and a second substrate opposed to the first substrate, and disposing a sealant between the first substrate and the second substrate, for example, in a peripheral region to seal the first substrate and the second substrate, wherein the sealant between the adjacent display regions between the first substrate and the second substrate includes a pre-cutting position. Furthermore, a curing barrier layer is disposed at a position corresponding to the pre-cutting position between the first substrate and the sealant, or at a position corresponding to the pre-cutting position between the second substrate and the sealant. Since the sealant needs UV curing, and the hardness of the cured sealant is relative high, the cured sealant is not easy to break during the cutting process for the display panel, and a fracture surface may be not located at the cutting position of the sealant between the adjacent display regions. In the present disclosure, the curing barrier layer is disposed at the pre-cutting position of the sealant between the adjacent display regions. As such, it can be ensured that the sealant at the pre-cutting position between the adjacent display regions will not be cured during UV irradiation curing, so that the sealant at such position will be easy to break. Then it can be ensured that the sealant will break at the pre-cutting position during cutting process, to achieve the narrow bezel design of the display panel. According to the method for fabricating the display panel in the present embodiment, the display screen will be available rather than defective due to the accurate break position, which in turn reduces the production cost and improves the performance of the display screen.

An embodiment of present disclosure provides a display device, which includes any of the display panels provided in the embodiments corresponding to FIGS. 1-6.

The display device according to the embodiments of present disclosure includes: a first substrate, a second substrate opposed to the first substrate, a sealant disposed between the first substrate and the second substrate, for example, in a peripheral region to seal the first substrate and the second substrate, and the sealant between the adjacent display regions between the first substrate and the second substrate includes a pre-cutting position. Furthermore, a curing barrier layer is disposed at a position corresponding to the pre-cutting position on the first substrate, or at a position corresponding to the pre-cutting position on the second substrate. Since the sealant needs UV curing, and the hardness of the cured sealant is relative high, the cured sealant is not easy to break during the cutting process for the display panel, and a fracture surface may be not located at the cutting position of the shared sealant. In the present disclosure, the curing barrier layer is disposed at the pre-cutting position of the sealant between the adjacent display regions. As such, it can be ensured that the sealant at the pre-cutting position between the adjacent display regions will not be cured during UV irradiation curing, so that the sealant at such position will be easy to break. Then it can be ensured that the sealant will break at the pre-cutting position during cutting process, to achieve the narrow bezel design of the display panel. According to the display device in the present embodiment, the display screen will be available rather than defective due to the accurate break position, which in turn reduces the production cost and improves the performance of the display screen.

The foregoing detailed description of the disclosure has been presented for purposes of illustration and description. It is not intended to be exhaustive or to limit the disclosure to the precise form disclosed. Many modifications and variations are possible in light of the above teaching. The described embodiments were chosen in order to best explain the principles of the disclosure and its practical application to thereby enable the skilled in the art to best utilize the disclosure in various embodiments and with various modifications as are suited to the particular use contemplated. It is intended that the scope of the disclosure be defined by the claims appended hereto.

1. A display panel, comprising:
a first substrate;
a second substrate, opposed to the first substrate;
a sealant, disposed between the first substrate and the second substrate to seal the first substrate and the second substrate, and the sealant between adjacent display regions between the first substrate and the second substrate including a pre-cutting position; and
a curing barrier layer, disposed at a position corresponding to the pre-cutting position on a surface facing the second substrate of the first substrate and/or on a surface facing the first substrate of the second substrate,
wherein the sealant covers the curing barrier layer.

2. The display panel according to claim 1, wherein a size of a region in which the curing barrier layer is located on the surface of the first substrate or the second substrate is equal to a size of a region corresponding to the pre-cutting position on the surface of the first substrate or the second substrate.

3. The display panel according to claim 1, wherein,
the pre-cutting position is a position corresponding to a central axis of the sealant shared by the adjacent display regions, and a direction of the central axis is a direction perpendicular to a direction of a line width of the sealant between the adjacent display regions.

4. The display panel according to claim 1, further comprising a first alignment layer disposed on the surface facing the second substrate of the first substrate, wherein, the curing barrier layer is disposed in a same layer as the first alignment layer.

5. The display panel according to claim 4, wherein a material of the curing barrier layer is a same as that of the first alignment layer.

6. The display panel according to claim 1, further comprising a second alignment layer disposed on the surface facing the first substrate of the second substrate, wherein, the curing barrier layer is disposed in a same layer as the second alignment layer.

7. The display panel according to claim 6, wherein a material of the curing barrier layer is a same as that of the second alignment layer.

8. The display panel according to claim 1, wherein a thickness of the curing barrier layer is about 800 Å˜300 Å.

9. A method for fabricating a display panel, comprising:
providing a first substrate;
providing a second substrate opposed to the first substrate;
disposing a sealant between the first substrate and the second substrate to seal the first substrate and the second substrate, the sealant between adjacent display regions between the first substrate and the second substrate comprising a pre-cutting position;
forming a curing barrier layer on a surface facing the second substrate of the first substrate and at a position corresponding to the pre-cutting position, and/or, forming a curing barrier layer on a surface facing the first substrate of the second substrate and at a position corresponding to the pre-cutting position,
wherein the sealant covers the curing barrier layer.

10. The method according to claim 9, wherein a size of a region in which the formed curing barrier layer is located on the surface of the first substrate or the second substrate is equal to a size of a region corresponding to the pre-cutting position on the surface of the first substrate or the second substrate.

11. The method according to claim 9, further comprising:
forming a first alignment layer on the surface facing the second substrate of the first substrate;
forming a curing barrier layer on a surface facing the second substrate of the first substrate and at a position corresponding to the pre-cutting position comprises:
forming the curing barrier layer in a same layer as the first alignment layer and at the position corresponding to the pre-cutting position.

12. The method according to claim 11, wherein forming the curing barrier layer in a same layer as the first alignment layer and at the position corresponding to the pre-cutting position comprising:
forming the curing barrier layer with a same material as the first alignment layer in a same layer of the first alignment layer and at the position corresponding to the pre-cutting position by using a same process of forming the first alignment layer.

13. The method according to claim 9, further comprising:
forming a second alignment layer on the surface facing the first substrate of the second substrate;
forming a curing barrier layer on a surface facing the first substrate of the second substrate and at a position corresponding to the pre-cutting position comprising
forming the curing barrier layer in a same layer of the second alignment layer and at a position corresponding to the pre-cutting position.

14. The method according to claim 13, wherein forming the curing barrier layer in a same layer of the second alignment layer and at a position corresponding to the pre-cutting position comprising:
forming the curing barrier layer with a same material as the second alignment layer in a same layer of the second alignment layer and at the position corresponding to the pre-cutting position by using a same process of forming the second alignment layer.

15. A display device, comprising the display panel according to claim 1.
